(19) United States
(12) Patent Application Publication
(10) Pub. No.: US 2022/0020323 A1
(43) Pub. Date: Jan. 20, 2022

(54) PULSE WIDTH MODULATION FOR MULTI-PIXEL DENSITY OLED DISPLAY

(71) Applicant: GOOGLE LLC, Mountain View, CA (US)

(72) Inventors: Sangmoo Choi, Palo Alto, CA (US); Wonjae Choi, San Jose, CA (US); Sang Young Youn, Cupertino, CA (US); Sun-il Chang, San Jose, CA (US)

(21) Appl. No.: 17/311,632

(22) PCT Filed: Aug. 1, 2019
(86) PCT No.: PCT/US2019/044680

§ 371 Date: Jun. 7, 2021

(51) Int. Cl. G09G 3/3225; G09G 3/20

(52) U.S. Cl. CPC G09G 3/3225; G09G 2320/0233; G09G 3/2014

(57) ABSTRACT

A method for driving an organic light emitting diode display having a first plurality of pixel lines having a first pixel density and a second plurality of pixel lines having a second pixel density higher than the first pixel density, the method including driving the first and second plurality of pixel lines with corresponding drive signals at a frame rate at which frames are displayed, where during each of the frames the drive signals have a pixel on time during which pixels in the pixel lines driven by the drive signals emit light and a pixel off time during which pixels in the pixel lines driven by the drive signals are dark, where the pixel on times and the pixel off times are varied between the drive signals to reduce variations in luminance.

### BACKGROUND

Electronic devices include displays that can change in brightness.

### SUMMARY

This specification describes techniques, methods, systems, and other mechanisms for pulse width modulation for multi-pixel density organic light-emitting diode (OLED) displays. An OLED display that has portions with multiple different pixel densities across the display may vary in brightness when the portions are driven based on similar pulse width modulation.

For example, a first portion of the display may have pixels that are a similar size to a second portion of the display and only have half the number of pixels that the second portion has. Accordingly, if the two portions of the display are driven with pulses of similar width, the first portion may appear dimmer than the second portion as fewer pixels per square inch or unit area in the first portion may emit light compared to the second portion.

In order to keep luminance of the lower pixel density region similar to the higher pixel density region, the luminance of each pixel in the lower pixel density region may be increased. For example, each of the pixels in the lower pixel density region may be modulated so that each pixel appears twice as bright as each pixel in the higher pixel density region. Luminance of pixels may be controlled through modulation of the pixels. Pixels that emit light for a longer time may appear to be brighter than pixels that emit light shorter. For example, if a pulse occurs every sixteen milliseconds, pixels that emit light for eight milliseconds every pulse may appear to be brighter to the human eye than pixels that emit light for two milliseconds every pulse.

Modulating the pixels may be done through pulse width modulation of signals that drive the pixels. These signals are also referred to herein as drive signals. For example, a system may use pulse width modulation to provide a first set of drive signals to pixels in a lower pixel density region and a second set of drive signals to pixels in a higher pixel density region, where the first set of drive signals drives the pixels in the lower pixel density region to emit light for a longer time than the second set of drive signals drives the pixels in the higher pixel density region to emit light.

Accordingly, pulse width modulation for multi-pixel density OLED displays may enable multi-pixel density OLED displays to have a uniform luminance even between portions of the OLED displays that have different pixel densities. Having a uniform luminance may hide the difference in pixel density of portions of the display from viewers and users may not even realize the display has portions with different pixel densities.

In general, one innovative aspect of the subject matter described in this specification can be embodied in a method for driving an organic light emitting diode OLED display having a first plurality of pixel lines having a first pixel density and a second plurality of pixel lines having a second pixel density higher than the first pixel density, the method including driving the first and second plurality of pixel lines with corresponding drive signals at a frame rate at which frames are displayed, where during each of the frames the drive signals have a pixel on time during which pixels in the pixel lines driven by the drive signals emit light and a pixel off time during which pixels in the pixel lines driven by the drive signals are dark, where the pixel on times and the pixel off times are varied between the drive signals of the first plurality of pixel lines and the drive signals of the second plurality of pixel lines to reduce variations in luminance between the first plurality of pixel lines and the second plurality of pixel lines.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other embodiments can each optionally include one or more of the following features. In some aspects, the pixel on time of the drive signals of the first plurality of pixel lines is greater than the pixel on time of the drive signals of the second plurality of pixel lines. In some implementations, the pixel on time of the drive signals of the first plurality of pixel lines is twice as long as the pixel on time of the drive signals of the second plurality of pixel lines. In certain aspects, the pixel on time of the drive signals of the first plurality pixel is determined based on difference between the first pixel density and the second pixel density.

In some aspects, driving the first and second plurality of pixel lines with corresponding drive signals at a frame rate at which frames are displayed includes determining a brightness for the display and determining the drive signals based on the brightness. In some implementations, actions include determining the drive signals so that the luminance of the first plurality of pixel lines is substantially identical to the luminance of the second plurality of pixel lines and corresponds to the brightness that was determined.

In certain aspects, driving the first and second plurality of pixel lines with corresponding drive signals at a frame rate at which frames are displayed includes providing a first emission start pulse for a first emission signal generator to generate the drive signals for the first plurality of pixel lines and a second emission start pulse for a second emission signal generator to generate the drive signals for the second plurality of pixel lines.

In some implementations, the second emission start pulse has a pixel on time that starts after a pixel on time of the first emission start pulse starts. In some aspects, the first emission signal generator generates the drive signals such that a start of the pixel on time for each of the drive signals for the first plurality of pixel lines is offset by a differing period of time.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system that includes a multi-pixel density OLED display using pulse width modulation.

FIG. 2 is a block diagram of an example circuitry for pulse width modulation of a multi-pixel density OLED display.

FIG. 3 is an illustration of example emission start pulse signals for pulse width modulation of a multi-pixel density OLED display.

FIG. 4 is an illustration of example drive signals for pulse width modulation of a multi-pixel density OLED display

Like reference numbers and designations in the various drawings indicate like elements.

### DETAILED DESCRIPTION

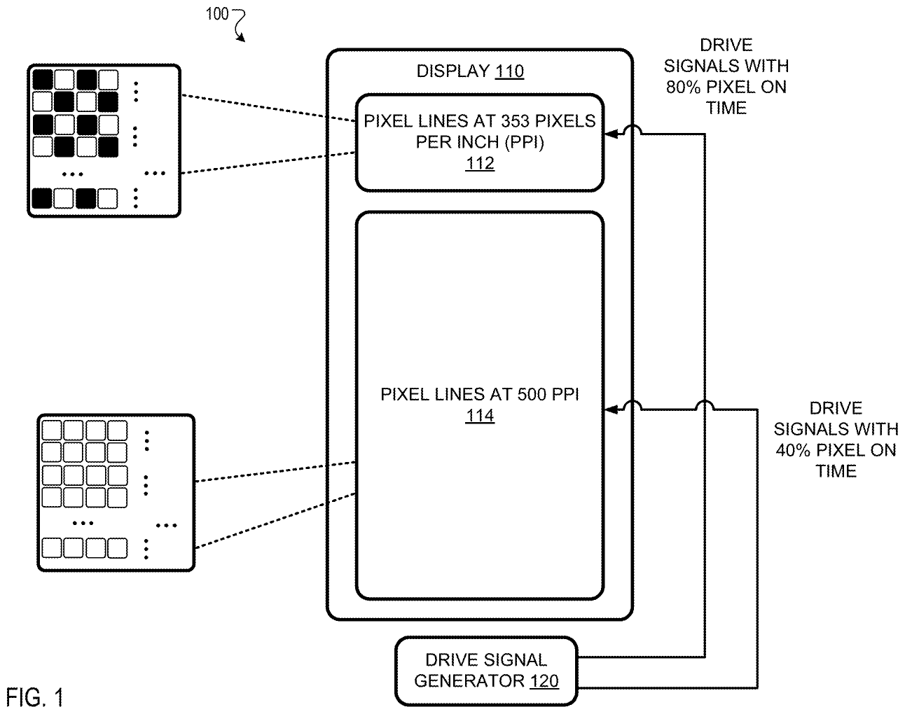

FIG. 1 is a block diagram of an example system 100 that includes a multi-pixel density OLED display 110 using pulse width modulation and a drive signal generator 120. The display includes a first portion 112 and a second portion 114, where the first portion 112 includes pixel lines at a pixel density that is lower than a pixel density of pixel lines included in the second portion 114.

For example, the first portion 112 may include multiple pixel lines at a pixel per inch density of three hundred fifty three and the second portion 114 may include multiple pixel lines at a pixel per inch density of five hundred. As shown in FIG. 1, the first portion 112 and the second portion 114 may include pixels that have the same sizes between the portions, but the first portion 112 may have a lower pixel density than the second portion 114 as a pattern of pixels in the first portion 112 may correspond to the pattern of the pixels in the second portion 114 where every other pixel in the pattern of the pixels in the second portion is missing.

A pixel line may be considered a line of pixels. For example, a pixel line may include fifty pixels in a row that are serially coupled together and driven by a single drive signal may be a single pixel line. Each pixel line may extend across an entirety of the corresponding portion of the display. For example, the pixel lines in the first portion 112 may extend across an entire width of the display 110 and the pixel lines in the second portion 114 may extend across the entire width of the display 110. The display 110 may be formed of multiple pixel lines arranged in parallel rows from a top of the display 110 to the bottom of the display 110.

The drive signal generator 120 may generate drive signals that drive the pixels in the pixel lines to emit light and be dark. For example, the drive signal generator 120 may drive a first set of drive signals to the first portion 112 and a second set of drive signals to the second portion 114. Each of the pixel lines, e.g., pixel row lines, may receive its own respective drive signal. For example, where the first portion 112 includes two hundred pixel lines and the second portion 114 includes eight hundred pixel lines, the driver signal generator 120 may generate a first set of two hundred drive signals, one for each of the pixel lines in the first portion 112, and a second set of eight hundred drive signals, one for each of the pixel lines in the second portion 114.

Each drive signal may be driven at a frame rate at which frames are displayed. For example, each drive signal may have a frame rate of sixty frames per second, so each frame may be displayed for about sixteen milliseconds. The time that each frame is displayed may be referred to as a frame time. Each drive signal may correspond with pixel on times and pixel off times. A pixel on time may correspond to an amount of time that the drive signal drives a pixel to emit light, and a pixel off time may correspond to an amount of time that the drive signal drives the pixel to be dark. For example, driving a pixel line with a drive signal with 80% pixel on time per frame may cause pixels in the pixel line to be turned on 80% of the time per frame. In another example, driving a pixel line with a drive signal with a 40% pixel on time may cause pixels in the pixel line to be turned on 40% of the time.

In the example where the frame time is sixteen milliseconds, a drive signal with a frame rate of sixty frames per second with a pixel on time of 80% may result in pixels driven by the drive signal emitting light for about thirteen milliseconds every sixteen milliseconds. In another example, a drive signal with a frame rate of sixty frames person second with a pixel on time of 40% may result in pixels driven by the drive signal emitting light for about seven milliseconds every sixteen milliseconds.

The drive signal generator 120 may vary the drive signals for the first portion 112 and the second portion 114 to reduce variations in luminance between the pixel lines in the first portion 112 and the pixel lines in the second portion 114. For example, the drive signal generator 120 may generate drive signals with 80% pixel on time to the first portion 112 and 40% pixel on time to the second portion 114 so that even though the first portion 112 only has half the pixel density of the second portion 114, the first portion 112 and the second portion 114 appear equally bright. Accordingly, a person viewing the display 110 may not even be aware that the display 110 includes portions with different pixel densities.

As shown in FIG. 1, the pixel on time of the drive signals of the pixel lines for the first portion 112 may be greater, e.g., twice as long, than the pixel on time of the drive signals of the pixel lines for the second portion 114. The pixel on times of the drive signals for the first portion 112 and the second portion 114 may be determined based on a difference between the pixel density of the first portion 112 and the pixel density of the second portion 114.

For example, the pixel density of the first portion 112 may be known to be half the pixel density of the second portion 114 so the drive signal generator 120 may be programmed or circuitry physically arranged so that the pixel on time of the first portion 112 is always double the pixel on time of the pixel on time of the second portion. In another example, the pixel density of the first portion 112 may be known to be a quarter of the pixel density of the second portion 114 so the drive signal generator 120 may be programmed or circuitry physically arranged so that the pixel on time of the first portion 112 is always quadruple the pixel on time of the pixel on time of the second portion.

In some implementations, the drive signal generator 120 may determine a brightness for the display 110 and then determine drive signals based on the brightness. For example, the drive signal generator 120 may determine that the display 110 is to be shown at 40% brightness and, in response, generate drive signals for the first portion 112 with pixel on times of 40% and drive signals for the second portion 114 with pixel on times of 20%. In another example, the drive signal generator 120 may determine that the display 110 is to be shown at 60% brightness and, in response, generate drive signals for the first portion 112 with pixel on times of 60% and drive signals for the second portion 114 with pixel on times of 30%.

In some implementations, the drive signal generator 120 may determine the drive signals based on the brightness through identifying pixel on times that were previously mapped to the brightness. The drive signal generator 120 may store a pixel on time for the drive signals for the first portion 112 labeled with a corresponding brightness.

For example, the drive signal generator 120 may store a table that includes a first entry that maps 80% brightness to a 80% pixel on time for the first portion 112 and a 40% pixel on time for the second portion 114, a second entry that maps 70% brightness to a 70% pixel on time for the first portion 112 and a 35% pixel on time for the second portion 114, and corresponding entries for other brightnesses.

In other implementations, the drive signal generator 120 may determine the drive signals based on the brightness through circuitry. For example, the drive signal generator 120 may include circuitry that receives the brightness and outputs drive signals that correspond to the brightness. In another implementation, the drive signal generator 120 may use a formula that receives a brightness as an input and outputs drive signals based on the input.

While FIG. 1 shows a display with two portions with different pixel density, the drive signal generator 120 may similarly drive a display with three, four, or more portions with different pixel densities based on providing drive signals with different pulse widths to the corresponding portions. For example, the drive signal generator 120 may drive a third portion of the display with four times more pixels per unit area with a drive signal with 20% pixel on time so that the third portion appears equally bright as the first portion 112 driven with a drive signal with 80% pixel on time.

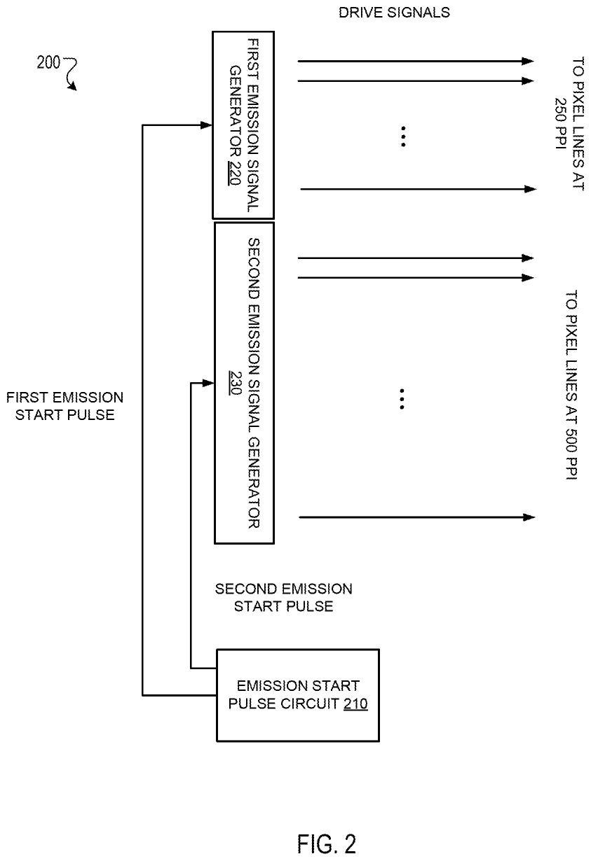

FIG. 2 is a block diagram of an example circuitry 200 for pulse width modulation of a multi-pixel density OLED display. The circuitry 200 may be included in the drive signal generator 120 shown in FIG. 1. The circuitry 200 includes an emission start pulse circuit 210, a first emission signal generator 220, and a second emission signal generator 230.

The emission start pulse circuit 210 may generate a first emission start pulse that drives the first emission signal generator 220 and a second emission start pulse circuit that drives the second emission generator 230. For example, the emission start pulse circuit 210 may be connected to the first emission signal generator 220 by a conductive connection and output the first emission start pulse through the conductive connection, and be connected to the second emission signal generator 230 by another conductive connection and output the second emission start pulse through the other conductive connection.

The first emission signal generator 220 may be circuitry that receives the first emission start pulse and generates drive signals to pixel lines. For example, the first emission signal generator 220 may receive the first emission start pulse and generate corresponding drive signals for each of the pixel lines of the first portion 112 based on the first emission start pulse.

Similarly, the second emission signal generator 230 may be circuitry that receives the second emission start pulse and generates drive signals to pixel lines. For example, the second emission signal generator 230 may receive the second emission start pulse and generate corresponding drive signals for each of the pixel lines of the second portion 114 based on the second emission start pulse.

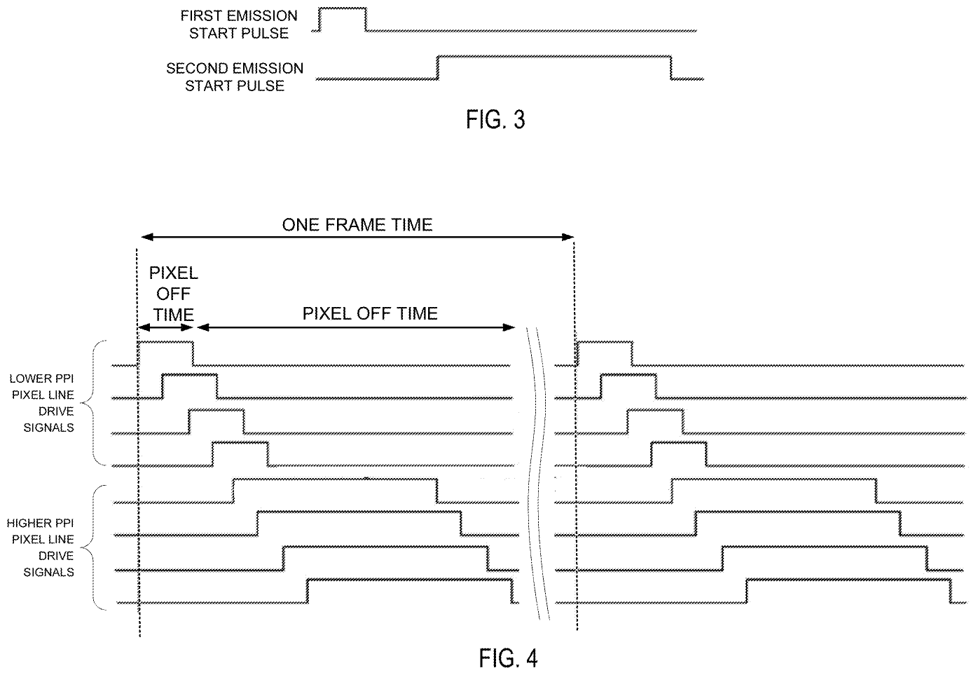

FIG. 3 is an illustration of example emission start pulse signals for pulse width modulation of a multi-pixel density OLED display. The first emission start pulse shown in FIG. 3 may correspond to the first emission start pulse output from the emission start pulse circuit 210 to the first emission signal generator 220. The first emission start pulse may have a pixel on time that corresponds to the pixel on time of the drive signals of the first portion 112. The emission start pulses may have low and high values, where a low value corresponds to driving a pixel to emit light and a high value corresponds to driving a pixel to be dark. The emission start pulse, in some cases, may have the opposite polarity in its voltage levels depending on the circuit structures of the emission signal generators 220, 230.

Similarly, the first emission start pulse shown in FIG. 3 may correspond to the second emission start pulse output from the emission start pulse circuit 210 to the second emission signal generator 230. The second emission start pulse may have a pixel on time that corresponds to the pixel on time of the drive signals of the second portion 114.

As shown in FIG. 3, the pixel on time of the first emission start pulse may start before the pixel on time of the second emission start pulse. For example, the first emission start pulse may go from low to high and then low again before the second emission start pulse goes from low to high. The starts of the pixel on time for the emission start pulses may be different because the first emission start pulse may be used to drive pixel lines that appear above the pixel lines driven based on the second emission start pulse.

In some implementations, a display that is driven based on the emission start pulses may only be able to update colors shown by pixel lines a single pixel line at a time, and updating the colors may require some time. For example, the display may require five μs to update a pixel line, and update each pixel line of the display serially starting from top to bottom. Accordingly, if the pixel lines for the first portion 112 appear above the pixel lines for the second portion 114, the pixel on time of the second emission start pulse starts only after all the pixel lines in the first portion 112 are updated. For example, if there are two hundred pixel lines in the first portion 112, then the pixel on time for the second emission start pulse may begin one millisecond after the pixel on time for the first emission start pulse begins.

FIG. 4 is an illustration of example drive signals for pulse width modulation of a multi-pixel density OLED display. The drive signals may be the drive signals shown in FIG. 1 as being generated by the drive signal generator 120 and received by the pixel lines in the first portion 112 and the second portion 114. For example, the top four drive signals in FIG. 4 may correspond to drive signals with 80% pixel on time for the first portion 112 and the bottom four drive signals in FIG. 4 may correspond to drive signals with 40% pixel on time for the second portion 114. While FIG. 4 is shown as only including eight drive signals, the number of drive signals to a display corresponds to the number of pixel lines in the display.

As shown in FIG. 4, the drive signals to the first portion 112 have a shape that matches a shape of the first emission start pulse, and each of the drive signals is offset by an amount of time needed to update colors of pixel lines. For example, where each pixel line takes five μs to update, the shape of a drive signal of a particular pixel line of the first portion 112 may be offset by five μs from a drive signal for a pixel line immediately above the particular pixel line.

Similarly, the drive signals to the second portion 114 have a shape that matches a shape of the second emission start pulse, and each of the drive signals is offset by an amount of time needed to update colors of pixel lines. For example, where each pixel line takes five μs to update, the shape of a drive signal of a particular pixel line of the second portion 114 may be offset by five μs from a drive signal for a pixel line immediately above the particular pixel line.

In some implementations, pixel lines of the display may be driven in pairs. For example, a first drive signal may drive a first pixel row and a second pixel row immediately below the first pixel row, and a second drive signal may drive a third pixel row and a fourth pixel row immediately below the third pixel row. Driving pixel rows in pairs may allow for reducing a physical footprint of the emission signal generator that generates the drive signals for the pixel rows. For example, an emission signal generator that drives pixel rows in pairs may be substantially half the size of an emission signal generator that drives pixel rows individually.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (erasable programmable read-only memory), EEPROM (electrically erasable programmable read-only memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), LCD (liquid crystal display) or OLED (organic light emitting diode) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a user computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for driving an organic light emitting diode (OLED) display having a first plurality of pixel lines having a first pixel density and a second plurality of pixel lines having a second pixel density higher than the first pixel density, the method comprising:
driving the first and second plurality of pixel lines with corresponding drive signals at a frame rate at which frames are displayed, where during each of the frames the drive signals have a pixel on time during which pixels in the pixel lines driven by the drive signals emit light and a pixel off time during which pixels in the pixel lines driven by the drive signals are dark,
wherein the pixel on times and the pixel off times are varied between the drive signals of the first plurality of pixel lines and the drive signals of the second plurality of pixel lines to reduce variations in luminance between the first plurality of pixel lines and the second plurality of pixel lines.

2. The method of claim 1, wherein the pixel on time of the drive signals of the first plurality of pixel lines is greater than the pixel on time of the drive signals of the second plurality of pixel lines.

3. The method of claim 2, wherein the pixel on time of the drive signals of the first plurality of pixel lines is twice as long as the pixel on time of the drive signals of the second plurality of pixel lines.

4. The method of claim 1, wherein the pixel on time of the drive signals of the first plurality pixel is determined based on difference between the first pixel density and the second pixel density.

5. The method of claim 1, wherein driving the first and second plurality of pixel lines with corresponding drive signals at a frame rate at which frames are displayed comprises:
determining a brightness for the display; and
determining the drive signals based on the brightness.

6. The method of claim 5, comprising:
determining the drive signals so that the luminance of the first plurality of pixel lines is substantially identical to the luminance of the second plurality of pixel lines and corresponds to the brightness that was determined.

7. The method of claim 1, wherein driving the first and second plurality of pixel lines with corresponding drive signals at a frame rate at which frames are displayed comprises:
providing a first emission start pulse for a first emission signal generator to generate the drive signals for the first plurality of pixel lines and a second emission start pulse for a second emission signal generator to generate the drive signals for the second plurality of pixel lines.

8. The method of claim 7, wherein the second emission start pulse has a pixel on time that starts after a pixel on time of the first emission start pulse starts.

9. The method of claim 7, wherein the first emission signal generator generates the drive signals such that a start of the pixel on time for each of the drive signals for the first plurality of pixel lines is offset by a differing period of time.

10. An apparatus comprising:
an organic light emitting diode (OLED) display having a first plurality of pixel lines having a first pixel density and a second plurality of pixel lines having a second pixel density higher than the first pixel density; and
circuitry configured for:
driving the first and second plurality of pixel lines with corresponding drive signals at a frame rate at which frames are displayed, where during each of the frames the drive signals have a pixel on time during which pixels in the pixel lines driven by the drive signals emit light and a pixel off time during which pixels in the pixel lines driven by the drive signals are dark,
wherein the pixel on times and the pixel off times are varied between the drive signals of the first plurality of pixel lines and the drive signals of the second plurality of pixel lines to reduce variations in luminance between the first plurality of pixel lines and the second plurality of pixel lines.

11. The apparatus of claim 10, wherein the pixel on time of the drive signals of the first plurality of pixel lines is greater than the pixel on time of the drive signals of the second plurality of pixel lines.

12. The apparatus of claim 11, wherein the pixel on time of the drive signals of the first plurality of pixel lines is twice as long as the pixel on time of the drive signals of the second plurality of pixel lines.

13. The apparatus of claim 10, wherein the pixel on time of the drive signals of the first plurality pixel is determined based on difference between the first pixel density and the second pixel density.

14. The apparatus of claim 10, wherein driving the first and second plurality of pixel lines with corresponding drive signals at a frame rate at which frames are displayed comprises:
determining a brightness for the display; and
determining the drive signals based on the brightness.

15. The apparatus of claim 14, the circuitry configured for:
determining the drive signals so that the luminance of the first plurality of pixel lines is substantially identical to the luminance of the second plurality of pixel lines and corresponds to the brightness that was determined.

16. The apparatus of claim 10, wherein driving the first and second plurality of pixel lines with corresponding drive signals at a frame rate at which frames are displayed comprises:
providing a first emission start pulse for a first emission signal generator to generate the drive signals for the first plurality of pixel lines and a second emission start pulse for a second emission signal generator to generate the drive signals for the second plurality of pixel lines.

17. The apparatus of claim 16, wherein the second emission start pulse has a pixel on time that starts after a pixel on time of the first emission start pulse starts.

18. The apparatus of claim 16, wherein the first emission signal generator generates the drive signals such that a start of the pixel on time for each of the drive signals for the first plurality of pixel lines is offset by a differing period of time.

19. A non-transitory computer-readable medium storing software for driving an organic light emitting diode (OLED) display having a first plurality of pixel lines having a first pixel density and a second plurality of pixel lines having a second pixel density higher than the first pixel density, the software comprising instructions executable by one or more computers which, upon such execution, cause the one or more computers to perform operations comprising:
driving the first and second plurality of pixel lines with corresponding drive signals at a frame rate at which frames are displayed, where during each of the frames the drive signals have a pixel on time during which pixels in the pixel lines driven by the drive signals emit light and a pixel off time during which pixels in the pixel lines driven by the drive signals are dark,
wherein the pixel on times and the pixel off times are varied between the drive signals of the first plurality of pixel lines and the drive signals of the second plurality of pixel lines to reduce variations in luminance between the first plurality of pixel lines and the second plurality of pixel lines.

20. The medium of claim 19, wherein the pixel on time of the drive signals of the first plurality of pixel lines is greater than the pixel on time of the drive signals of the second plurality of pixel lines.
